(19) United States
(12) Patent Application Publication
(10) Pub. No.: US 2024/0054317 A1
(43) Pub. Date: Feb. 15, 2024

(54) NEURO-VECTOR-SYMBOLIC ARTIFICIAL INTELLIGENCE ARCHITECTURE

(71) Applicant: International Business Machines Corporation, Armonk, NY (US)

(72) Inventors: Michael Andreas Hersche, Zurich (CH); Abu Sebastian, Adliswil (CH); Abbas Rahimi, Rueschlikon (CH)

(21) Appl. No.: 17/817,470

(22) Filed: Aug. 4, 2022

(51) Int. Cl. G06N 3/04; G06V 10/771; G06V 10/82

(52) U.S. Cl. CPC G06N 3/04; G06V 10/771; G06V 10/82

(57) ABSTRACT

A computerized neuro-vector-symbolic architecture, that: receives image data associated with an artificial intelligence (AI) task; processes the image data using a frontend that comprises an artificial neural network (ANN) and a vector-symbolic architecture (VSA); and processes an output of the frontend using a backend that comprises a symbolic logical reasoning engine, to solve the AI task. The AI task, for example, may be an abstract visual reasoning task.

### BACKGROUND

The following disclosure is submitted under 35 U.S.C. 102(b)(1)(A):

### DISCLOSURE

HERSCHE et al., “A Neuro-vector-symbolic Architecture for Solving Raven's Progressive Matrices”, arXiv:2203.04571v1 [cs.LG] 9 Mar. 2022, 20 pages.

The invention relates to the field of artificial intelligence and machine learning.

Human fluid intelligence is the ability to think and reason abstractly and make inferences in a novel domain. In solving many types of problems, humans often employ two aspects of intelligence: sensory perception and abstract reasoning.

As opposed to computerized deep learning methods that blend perception and reasoning in a monolithic model, the reasoning capability is not necessarily interwoven with visual perception in humans. For instance, a person can close their eyes and build a scene representation through touch, followed by reasoning that remains effortless without the vision. This decoupling is at the core of hybrid systems that advocate combining sub-symbolic (e.g., neural networks) with symbolic artificial intelligence, aiming to reach human-level generalization. Among the hybrid systems, neuro-symbolic architectures separately handle the perception and reasoning aspects by using a combination of neural networks and symbolic approaches. Considerable effort has been devoted to integrating these two paradigms, that led to state-of-the-art performance of neuro-symbolic architectures in various tasks, e.g., visual question answering, causal video reasoning, and solving Raven's progressive matrices (RPM) test.

### SUMMARY

The following embodiments and aspects thereof are described and illustrated in conjunction with systems, tools and methods which are meant to be exemplary and illustrative, not limiting in scope.

One embodiment is directed to a system that comprises at least one hardware processor and a computer-readable storage medium having program code embodied therewith. The program code is executable by said at least one hardware processor to: receive image data associated with an artificial intelligence (AI) task; automatically process the image data using a frontend that comprises an artificial neural network (ANN) and a vector-symbolic architecture (VSA); and automatically process an output of the frontend using a backend that comprises a symbolic logical reasoning engine, to solve the AI task.

Another embodiment is directed to a method in which at least one hardware processor is operated to: receive image data associated with an artificial intelligence (AI) task; automatically process the image data using a frontend that comprises an artificial neural network (ANN) and a vector-symbolic architecture (VSA); and automatically process an output of the frontend using a backend that comprises a symbolic logical reasoning engine, to solve the AI task.

A further embodiment is directed to a computer program product comprising a computer-readable storage medium having program code embodied therewith, the program code executable by at least one hardware processor to: receive image data associated with an artificial intelligence (AI) task; process the image data using a frontend that comprises an artificial neural network (ANN) and a vector-symbolic architecture (VSA); and process an output of the frontend using a backend that comprises a symbolic logical reasoning engine, to solve the AI task.

In some embodiments, the processing of the image data using the frontend comprises: using the VSA to define possible nested compositional structures that may be depicted in the image data; and using the ANN to transform the image data to a hierarchy of objects depicted in the image data, according to the possible nested compositional structures defined by the VSA.

In some embodiments, each of the objects is represented by performing a binding operation between attributes of the respective object; and a scene comprising the objects is represented by performing a bundling operation between the object representations of the objects comprised in the scene.

In some embodiments, a query vector of the ANN resembles a bundling of vectorized object representations from a dictionary of the possible nested compositional structures; and the processing of the image data by the frontend further comprises: decomposing the query vector into its constituent vectorized object representations, inferring the attributes of the objects based on the decomposed query vector, and producing probability mass functions (PMFs) based on the inferred attributes of the objects.

In some embodiments, the processing of the output of the frontend using the backend comprises: transforming the PMFs into Fourier holographic reduced representations (FHRRs); based on the FHRRs, computing a rule probability of each possible rule of the AI task; and selecting the rule with the highest probability as a solution to the AI task.

In some embodiments, the computation of the rule probability comprises performing binding and unbinding operations on the FHRRs.

In some embodiments, the method further comprises, or the program code is further executable to, automatically learn weights of the ANN using an additive cross-entropy loss that is optimized by: updating trainable parameters of the ANN while a dictionary of the possible nested compositional structures frozen is maintained frozen.

In some embodiments, the AI task is an abstract visual reasoning task.

In some embodiments, a combination of the frontend and the backend is differentiable; and the method further comprises, or the program code is further executable to, automatically perform end-to-end training of the combination of the frontend and the backend.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A shows localist distributed representation for objects with color and shape attributes;

FIG. 1B shows high-dimensional vectorized representations and operators, continuing upon the object representations of FIG. 1A;

FIG. 1C is a heatmap showing absolute pairwise cosine similarity between vectorized representations, continuing upon FIG. 1B;

FIG. 2 is a block diagram of an exemplary system that employs a neuro-vector-symbolic architecture to perform one or more AI tasks;

FIG. 3A shows exemplary context and solution panels of a Raven's progressive matrices (RPM) test;

FIG. 3B shows a flowchart of training a neuro-vector perception frontend;

FIG. 3C shows an overall neuro-vector-symbolic architecture flowchart of solving an RPM test;

FIG. 4A shows a flowchart of steps of a symbolic logical reasoning engine backend;

FIG. 4B shows a flowchart of solving an ‘arithmetic plus’ rule on a number attribute by the symbolic logical reasoning engine backend;

FIG. 4C shows a flowchart of solving a ‘distribute three’ rule on a position attribute by the symbolic logical reasoning engine backend;

FIG. 5A is a graph comparing classification accuracy on the RAVEN dataset; and

FIG. 5B is a graph comparing classification accuracy on the I-RAVEN dataset.

### DETAILED DESCRIPTION

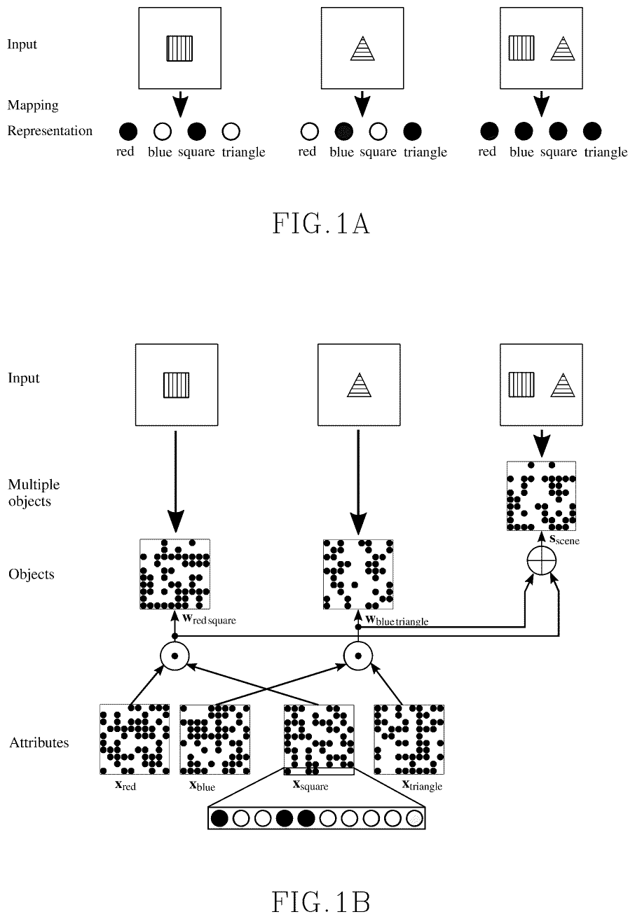

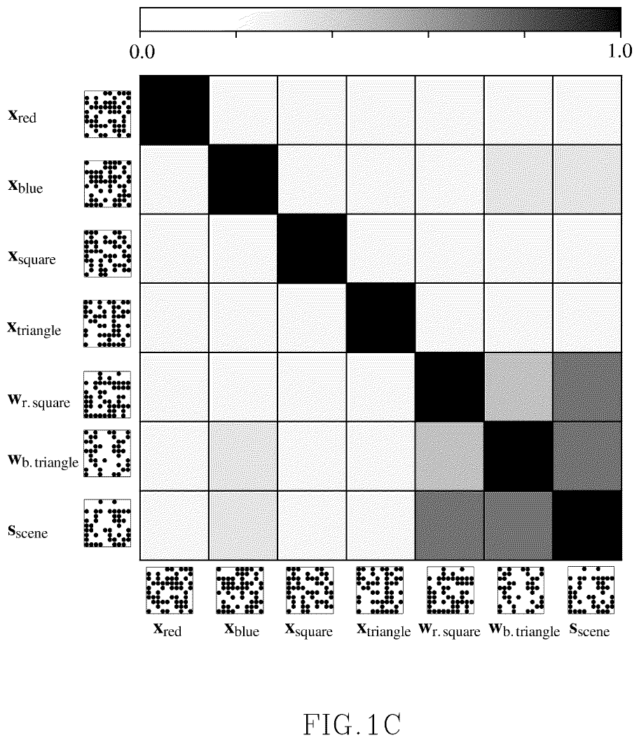

Neuro-symbolic architectures are not immune to the potential problems of their individual ingredients (i.e., the neuro and symbolic parts), which are explained in the following. The well-known “binding problem” in neural networks refers to their inability to recover distinct objects from their joint representation. This inability prevents the neural networks from providing an adequate description of real-world objects or situations that can be represented by hierarchical and nested compositional structures. When considering fully-local representations, an item of any complexity level can be represented by a single unit, e.g., by one-hot code. Such local representations limit the number of representable items to the number of available units in the pool, and hence cannot represent the combinatorial variety of real-world objects. To address this issue, the distributed representations can provide enough capacity to represent a combinatorially-growing number of compositional items. However, they face another issue known as “superposition catastrophe.” Let us consider four atomic items: red, blue, square, and triangle. For representing two composite objects, e.g., a red square and a blue triangle, the activity patterns corresponding to their atomic items are superimposed without increasing the dimensionality. As shown in FIG. 1A, this results in a blend pattern that is ambiguous because the patterns of all four atomic items are coactivated, which causes “ghost” or “spurious” memory for unavailable objects such as red triangle or blue square. In this figure, a localist distributed representation is used for objects with the color and shape attributes. The color attribute is mapped locally on a group of two neurons (red vs. blue, represented in the figure by horizontal and vertical hatching, respectively). The shape attribute is similarly mapped to square vs. triangle neurons. The mapping function is shown by the thick arrow. This results in two distinct activated patterns for a red square and a blue triangle. If one of these objects is presented, the responses of the output neurons are sufficient to determine the identity of the object (i.e., its color and shape). However, when both objects are presented, their elementary patterns (symbols) are simultaneously activated that leads to binding ambiguity meaning that the resulting blend activity is insufficient to determine which object is in which color. This is the “superposition catastrophe.”

The second ingredient of the neuro-symbolic architectures is the symbolic engine which is used for logical reasoning. The symbolic logical reasoning can be implemented, for instance, as a probabilistic abduction reasoning in the neuro-symbolic architecture for solving the RPM tests. Abduction refers to the process of selectively inferring a specific hypothesis that provides the best explanation to the sensory observations based on the symbolic background knowledge. Specifically, it collects the perception outputs from the RPM panels, and abduces the probability distributions over the rules. This forms an exhaustive search over a large number of symbolic logical constraints that describe all possible rule realizations that could govern the RPM tests. The search computational complexity rapidly increases for RPM panels with a large number of objects. This search problem might hinder the real-time execution of the symbolic logical reasoning.

The foregoing examples and limitations related therewith are intended to be illustrative and not exclusive. Other limitations of the related art will become apparent to those of skill in the art upon a reading of the specification and a study of the figures.

Disclosed herein is a computerized neuro-vector-symbolic architecture (“NVSA”) usable for performing artificial intelligence (AI) tasks. This architecture may be embodied in a method, a system, and a computer program product.

The disclosed architecture, advantageously, may exploit vector-symbolic architectures (VSAs) to address both the binding problem in perception and the exhaustive search problem in symbolic logical reasoning. The architecture may include a frontend that combines an artificial neural network (ANN) with VSA, and a backend comprised of a symbolic logical reasoning engine. The frontend addresses the binding problem, while the backend addresses the exhaustive search problem.

VSAs are computational models that rely on high-dimensional distributed vectors and algebraic properties of their powerful operations to incorporate the advantages of connectionist distributed representations as well as structured symbolic representations. In a VSA, all representations—from atomic to composite structures—are high-dimensional holographic vectors of the same, fixed dimensionality. These vectorized representations can be composed, decomposed, probed, and transformed in various ways using a set of well-defined operations, including binding, unbinding, bundling (i.e., additive superposition), permutations, inverse permutations, and associative memory (i.e., cleanup). VSAs have been used in analogical reasoning by relying on an oracle perception to provide access to the symbolic representation of the visual inputs.

The disclosed architecture, NVSA, may exploit the powerful vectorized representations and operators of VSA to devise the aforementioned frontend and backend.

Synergy between the frontend and backend may be achieved because vectorized representations and related operators of the frontend provide a general framework with a semantically-informed interface where both perception and reasoning parts can tap into its rich resources. The frontend constructs higher-level symbols (of multiple objects) by combining lower-level symbols (of individual objects) and more elementary symbols (of object attributes) through fixed-width vector arithmetic; see, for example, FIG. 1B, which illustrates high-dimensional vectorized representations and operators, continuing upon the example of FIG. 1A. The high-dimensional distributed vectorized representations and operators of VSA can address the so-called “superposition catastrophe” problem. At the lowest level of the hierarchy, the four attribute values are represented by randomly drawing four d-dimensional vectors (x_{red}, . . . ). The vectors are dense binary, and arranged as d=10×10 for the sake of visual illustration. At the next level, the red square object is described as a fixed-width product vector by binding two corresponding vectors (x_{red} ⊙x_{square}) whose similarity is nearly zero to all attribute vectors and other product vectors such as x_{blue}⊙x_{triangle}.

This results in a meaningful nested compositional structure. To connect it to raw visual sensory, the frontend provides a flexible means of neural network representation learning by using an advantageous additive cross-entropy loss. Effectively, the frontend maps the raw image of multiple objects to structural description, whereby probability mass functions for individual object attributes are extracted. These are transformed to vectorized representations in the backend. The backend also reformulates the first-order logical rules in the vectorized representations with the help of VSA operators. This conversion allows the backend to efficiently perform logical abduction and execution to predict the probability mass functions of the attributes in a generative manner. Finally, a solution to the AI task at hand (for example, an abstract visual reasoning task) may be selected (or otherwise provided) based on the divergence between the prediction and candidate solutions.

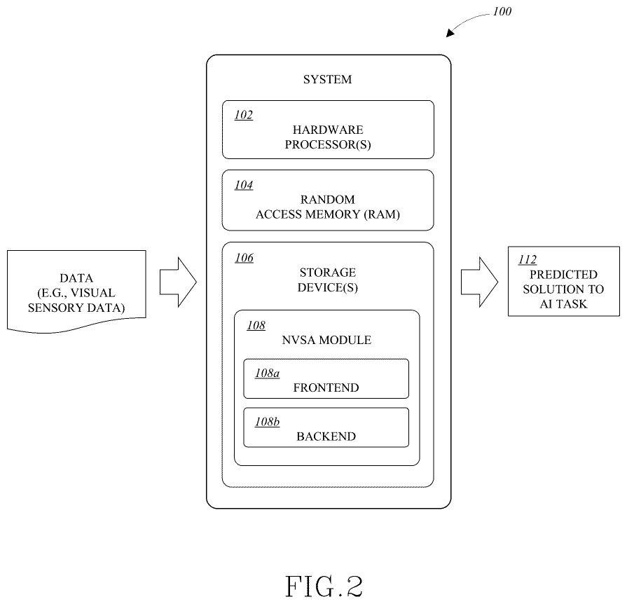

Reference is now made to FIG. 2, which shows a block diagram of an exemplary system 100 that employs NVSA to perform one or more AI tasks, according to an embodiment. System 100 may include one or more hardware processor(s) 102, a random-access memory (RAM) 104, and one or more computer-readable storage device(s) 106.

Storage device(s) 106 may have stored thereon program instructions and/or components configured to operate hardware processor(s) 102. The program instructions may include one or more software modules, such as an NVSA module 108 that is comprised of a frontend 108a and a backend 108b. The software components may include an operating system having various software components and/or drivers for controlling and managing general system tasks (e.g., memory management, storage device control, power management, etc.), and facilitating communication between various hardware and software components.

System 100 may operate by loading instructions of NVSA module 108 into RAM 104 as they are being executed by processor(s) 102. The instructions of NVSA module 108 may cause system 100 to receive data 110 (for example, visual sensory data), process it, and output a predicted solution 112 to a problem or a task posed by the data.

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 100 may be co-located or distributed, or the system may be configured to run as one or more cloud computing “instances,” “containers,” “virtual machines,” or other types of encapsulated software applications, as known in the art.

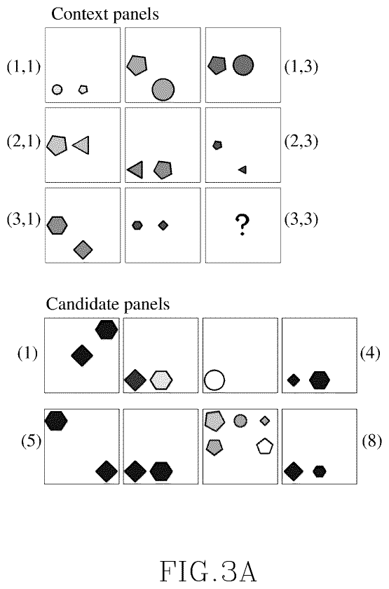

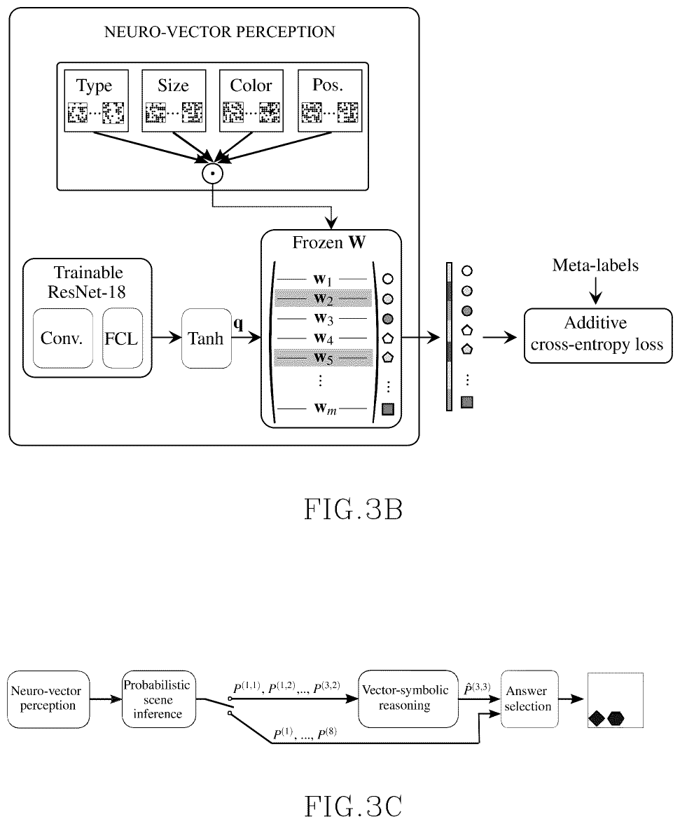

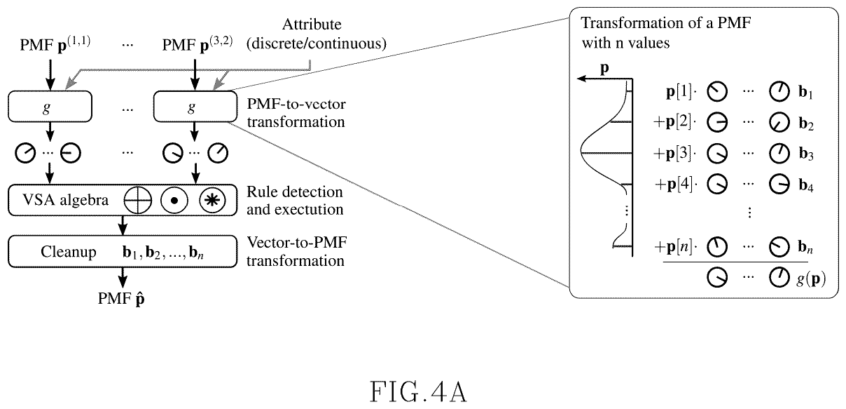

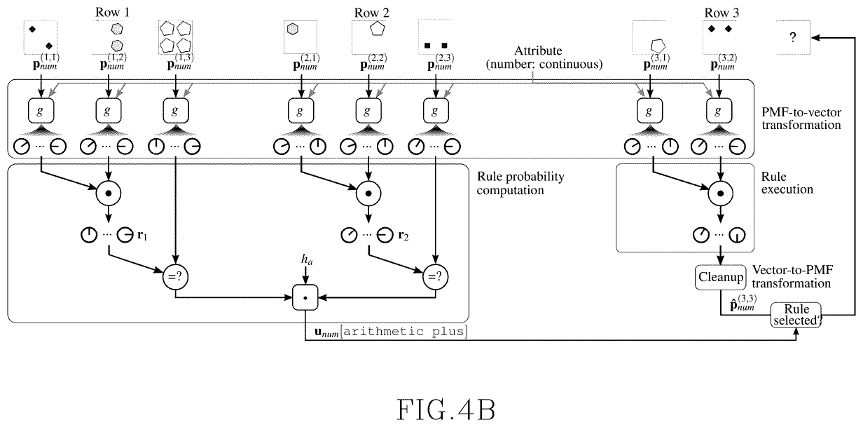

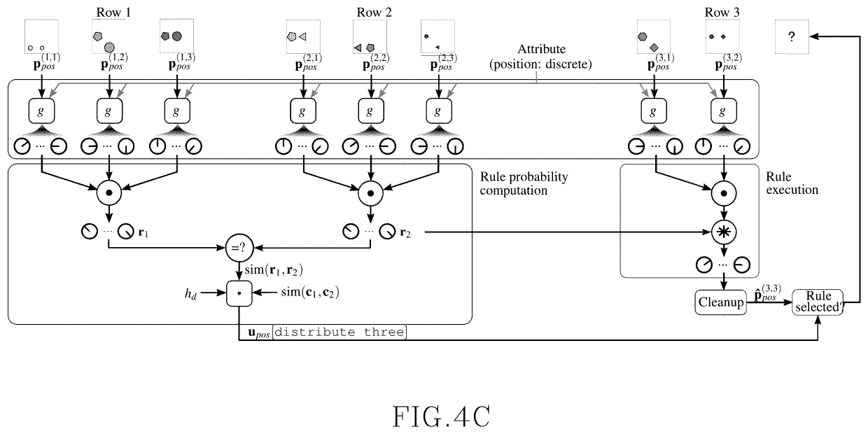

The instructions of NVSA module 108, specifically its frontend 108a and backend 108b, are now discussed with reference to the flowcharts of FIGS. 3A-3C and 4A-4C, which illustrate, overall, a method that employs NVSA to perform one or more AI tasks, in accordance with an embodiment.

Steps of this method may either be performed in the order they are presented or in a different order (or even in parallel), as long as the order allows for a necessary input to a certain step to be obtained from an output of an earlier step. In addition, the steps of this method may be performed automatically (e.g., by system 100 of FIG. 2), unless specifically stated otherwise.

### NVSA Frontend: Neuro-Vector Perception

Prior to describing the NVSA frontend 108a, provided here is a brief description of VSA. VSA represents data using random, high-dimensional vectors, whose entries may be restricted to being bipolar in certain scenarios. Initially, one or multiple codebooks are defined as X:={xᵢ}ᵢ₌₁^{m}, where the elements of each atomic d-dimensional vector xᵢ∈{−1, +1}^{d} are randomly drawn from a Rademacher distribution (i.e., equal chance of elements being “−1” or “+1”). Two vectors may be compared using the cosine similarity (sim). The similarity between two atomic vectors is close to zero with a high probability when d is sufficiently large, typically in the order of thousands; hence, all vectors in the codebooks are quasi-orthogonal with respect to each other.

For representing a given data structure, VSA provides a set of well-defined vector operations. Bundling (⊕) (also referred to as superposition, or addition) of two or more atomic vectors is defined as the element-wise sum with a subsequent bipolarization operation that sets the negative elements to “−1” and the positive ones to “+1”. This operation preserves similarity. On the other hand, binding (⊙) (also referred to as multiplication) of two or more vectors is defined with their element-wise product. Binding yields a vector that is dissimilar to its atomic input vectors. Every vector xᵢ∈X is its own inverse with respect to the binding operation, i.e., xᵢ⊙xᵢ=1, where 1 is the d-dimensional all 1-vector. Hence, the individual factors in a product can be exactly retrieved by unbinding: xᵢ⊙(xᵢ⊙xⱼ)=(xᵢ⊙xᵢ)⊙xⱼ=xⱼ.

The NVSA frontend includes an artificial neural network and the aforementioned vectorized representations and operators, hence it may be named here “neuro-vector perception.” It relies on the expressiveness of high-dimensional vectorized representations as a common language between the symbols and the neural network: the vectors can describe hierarchical symbols, and also serve as an interface to data-driven neural networks whose layers of transformation can be trained to generate such desired vectors, as shown in FIG. 3B. First, the vectorized part of the frontend defines the possible nested compositional structures by considering a hierarchy of what is depicted in the raw image: attributes, objects, and scene (containing a set of objects). Second, the neural network part is accordingly trained to transform the raw image of the scene into the defined structure.

The first process starts by randomly generating a set of codebooks for the attributes of interest, e.g., one codebook for the colors (x_{red}, x_{blue}), and another codebook for the shapes (x_{square}, x_{triangle}). Each codebook contains as many atomic d-dimensional vectors as there are attribute values. It therefore provides a symbolic meaning for individual atomic vectors. For describing an object with these two attributes, a product vector w can be computed by binding two vectors, one drawn from each of the codebooks, as FIG. 1B shows. For example, a red square object is represented as w=x_{red}⊙x_{square}. The random construction of the atomic vectors and the properties of multiplicative binding yield a unique w that is quasi-orthogonal (i.e., dissimilar) to the vectorized representations of all other attributes and their combinations (e.g., x_{blue}⊙x_{triangle}). This means that the expected cosine similarity between two different object vectors is approximately zero with a high probability. Therefore, when their vectorized representations are coactivated, it results in minimal interference such that each object can be recovered; see FIG. 1C, which is a heatmap showing absolute pairwise cosine similarity between vectorized representations. This quasi-orthogonality allows the vectorized representations to be coactivated with minimal interference. At the highest level, the two object vectors are bundled together by similarity-preserving bundling to describe the scene. The bundled vector is similar solely to those objects vectors and dissimilar to others.

It has been explained above how to derive the object vectors from the elementary attribute vectors. In the next level of the hierarchy, the interest lies in representing a set of objects in the scene. A scene with multiple objects can be represented by bundling together their object vectors: s=(x_{red}⊙x_{square})⊕(x_{blue}⊙x_{triangle}). The bundling operation creates an equally-weighted superposition of multiple objects, and preserves similarity; hence, the bundled vector s is similar to both object vectors present in the scene, and dissimilar to other vectors in the system, as shown in FIG. 1C. This similarity preservation property allows the bundled vector to be solely matched with its constituents object vectors, which avoids the superposition catastrophe by design (e.g., sim(s, x_{red}⊙x_{triangle})≈0).

In the following, it is discussed how to create these compositional structures suitable for solving the RPM test. The RPM test is given here merely as a representative example of an AI task, particularly an abstract visual reasoning task, that may be solved by the disclosed NVSA. In various embodiments, the NVSA is used in many types of machine vision tasks (including abstract visual reasoning tasks), which brings upon useful results in a wide variety of industries. Those of skill in the art will readily recognize that the input provided to the NVSA to solve a RPM test, which is the context and candidate panels of this test, may be replaced by other comparable visual sensory data (i.e., image data) that are part of and are associated with a different type of AI task.

Reference is now made to FIGS. 3A-3C, which show, respectively, an exemplary RPM test, a flow of training neuro-vector perception, and an overall NVSA method flow of solving a RPM test.

In the exemplary RPM test of FIG. 3A, the context panels are composed of eight panels followed by a missing panel at position (3,3). The candidate panels provide the potential candidates for the missing context panel. The correct panel, in this case, is the 6^{th} panel.

Solving the RPM test with NVSA may involve randomly generating a set of compact codebooks for the available attributes in the RAVEN dataset as T:={tᵢ}ᵢ₌₁⁵, S:={sᵢ}ᵢ₌₁⁶, C:={cᵢ}ᵢ₌₁¹⁰, and L:={Iᵢ}ᵢ₌₁²² which respectively represent the type, size, color, and position of a single object, considering the across-constellation equivalent positions with the same proportions (more details are provided below). d may be set, for example, to 512, which is sufficiently large to supply the atomic quasi-orthogonal vectors for every attribute value. Using these codebooks, the NVSA frontend computes a quasi-orthogonal vector for every possible combination of an object as the Hadamard product of its attribute vectors. Considering all possible combinations of attribute values (m=6600), it forms a dictionary W∈{−1, +1}^{m×d} which contains all possible object vectors as rows. Note that the used vector dimensionality for representing objects, d, is significantly lower than m. The dictionary W forms a meaningful space for structural object-based representations where every object can be further consolidated into higher-level multi-object structures, or decomposed into elementary attributes. This can be done by performing an associative memory search on W.

The following describes representation learning over nested compositional structures, within the NVSA frontend, and with particular reference to FIG. 3B. Generally, in this figure, the frontend uses a trainable neural network (ResNet-18) and a frozen dictionary W that is generated by the four codebooks of d-dimensional vectors to cover all possible objects (w₁, w₂, . . . , wₘ, where m=6600 in the RAVEN dataset and d<<m). The last fully connected layer of ResNet-18 with a tan h activation is connected to W. This dictionary forms a meaningful and semantically-informed vectorized representation of the objects that is kept frozen during training, while the weights of ResNet-18 are learned by using the additive cross-entropy loss of equation (11), further below. The training procedure directs ResNet-18 to generate a query vector (q) such that it resembles the superposition of the vectorized objects (w₂⊕w₅) available in the panel currently under the visual fixation. This results in merging the data-driven neural representation with the vectorized representation of the compositional objects.

In more detail, to avoid the pitfalls of pure symbolic approaches, the deep neural network representation learning over the defined nested structures is exploited such that an image panel X∈ [symbol] ^{r×r} with resolution r can be transformed and matched to the vectorized multi-object representation using a mapping f_{θ} with learnable parameters θ. To do so, a deep convolutional neural network may be used. ResNet-18 is given here as an example, but similar neural networks may be used instead. With ResNet-18, interface is made with its fully connected layer to W as shown in FIG. 3B. A hyperbolic tangent (tan h) activation is inserted at the output of ResNet-18 to guide its real-valued output towards the bipolar representation of W. The last fully connected layer has an output dimension d=512 and contains 512×512 trainable parameters. By exploiting the VSA principles, it is possible to superpose multiple (for example, k) objects in a d-dimensional vector from which the compound objects can be reliably recovered with their unique vectorized representations. On the other hand, an equivalent k-hot multi-label network would require a significantly larger number of parameters: the fully connected layer would require an output dimension of m=6600 and 512×6600 trainable parameters, which increases the number of parameters in the fully connected layer by a factor of 12.89×(3.38 M vs. 0.26 M) and the overall number of trainable parameters in ResNet-18 by a factor of 1.27×(14.55 M vs. 11.43 M).

The dictionary W is generated once, based on the initialization of codebook vectors, and is kept frozen during training. Let w₁, w₂, . . . , wₘ be the quasi-orthogonal representation of the object classes within W, where m is the number of single-object combinations. For an image panel X, containing k objects, with k target indices {yᵢ}ᵢ₌₁^{k}, the trainable parameters θ of ResNet-18 are optimized to maximize the similarity between its output query q=f_{θ}(X) and the bundled vector w_{y}_{₁}⊕ . . . ⊕w_{y}_{ₖ} using an additive cross-entropy loss together with batched gradient descent (details are provided further below).

Inferring object attributes and probability mass functions is now discussed, with particular reference to FIG. 3C. Generally, in this figure, it is shown that the neuro-vector perception frontend can generate a query vector that resembles the superposition of the present objects in a panel. Therefore, it can be decomposed to the object attributes. Then, a probabilistic scene inference computes a set of probability mass functions (PMFs) for the attributes. The PMFs are shown as P^{(i,j)} for every panel at location (i,j) in the context matrix. These are used in the NVSA backend (vector-symbolic reasoning) to predict the PMF of the missing panel (\hat{P}^{(3, 3)}). The final answer is selected by choosing the candidate panel that minimizes the divergence between the predicted PMF (\hat{P}^{(3, 3)}) and the PMF of the candidate panels (P⁽¹⁾, . . . , P⁽⁸⁾).

In more detail, during inference, ResNet-18 generates a query vector that can be decomposed into the constituent object vectors, each derived from a unique combination of the attributes. The decomposition performs a matrix-vector multiplication between the normalized dictionary matrix W and the normalized query vector, q, to obtain the cosine similarity scores z. The similarity scores are passed through a thresholded detection function g_{τ}, which returns the indices of the score vector whose similarity exceeds a threshold. The optimal threshold τ:=0.23 is determined by cross-validation and may be identical across all constellations. Since the structure of the dictionary matrix is known, it is possible to infer the attributes, namely, position, color, size, and type from the detected indices.

Based on the inferred (decoded) attributes of the detected objects, four probability mass functions (PMFs) are produced for every object, which are vₑₓᵢₛₜ, v_{type}, v_{size}, and v_{color}. Finally, all object PMFs are combined to five PMFs which represent the position, number, type, size, and color distribution of the entire panel. The PMFs are denoted by P: =(pₚₒₛ, pₙᵤₘ, p_{type}, p_{size}, p_{color}). More details on the PMF generation are provided further below. Given an RPM test, a PMF P^{(i,j)} is obtained for each of the eight context panels, indexed by their row i and column j, and a PMF P⁽ⁱ⁾ is obtained for each of the answer panels, as shown in FIG. 3C. The context PMFs (P^{(i,j)}) form the probabilistic scene representations that are used to find the underlying rule in the symbolic logical reasoning backend. The chosen rule is executed to generate \hat{P}^{(3, 3)} for the missing panel.

### NVSA Backend: Vector-Symbolic Reasoning

The NVSA backend efficiently implements the probabilistic abductive reasoning by exploiting the vectorized representations and the VSA operators. As the first step, the output of the frontend, namely, the multiple perceived attributes with the PMF of their values, are transformed into distributed vectorized representations in an appropriate vector space. This vector space allows the application of VSA operators to implement the first-order logical rules such as addition of the attributes, or subtraction, distribution, and more. These efficient vector-symbolic manipulations result in computing the rule probability for each possible rule, from which the most probable rule can be chosen and executed. These two main steps are shown in FIG. 4A, in which, first, a PMF of a discrete or a continuous attribute is transformed to a vectorized Fourier holographic reduced representation (FHRR) format. This transformation (g) is illustrated for the PMF of an attribute with n possible values. Next, the VSA algebra can be applied on the vectorized representations of PMFs to implement the rule of interest. Last, after executing the rule, the resulted vectorized representation can be cleaned up by doing an associative memory search on the codebook of values that returns an output PMF.

Vectorized representations of probability mass functions are now discussed.

The RAVEN dataset applies an individual rule to each of the five attributes (position, number, color, size, and type), which is either constant, progression, arithmetic, or distribute three (details are provided further below). The rules are applied row-wise across the context matrix. Based on the downstream rule, each attribute can be treated as continuous where there are relations among its set of values, or discrete where there are no explicit relations between the values. For instance, the color attribute is treated as discrete in the distribute three rule, while the arithmetic rule treats it as continuous. To make the vectorized transformation general, every attribute is treated as both discrete and continuous, and it is up to the rule to use the proper representation. To achieve this, for the vector-symbolic reasoning, the previously used bipolar dense representations are switched to FHRR. This is a more general VSA framework and permits the representation of continuous PMFs. The basis vectors in FHRR are d-dimensional, complex-valued, unary vectors where each element is a complex phasor with unit norm and an angle randomly drawn from a uniform distribution U(−ϕ, ϕ). The dense bipolar representations could be seen as a special case of the FHRR model where angles are restricted to {0, ϕ}. The binding in FHRR is defined as the element-wise modulo-2π sum; similarly, the unbinding is the element-wise modulo-2π difference. The bundling of two or more vectors is computed via the element-wise addition with a consecutive normalization step, which sets the magnitude of each phasor to unit magnitude. The similarity of two vectors is the sum of the cosines of the differences between the corresponding angles. Binding, unbinding, and similarity computation can be done using the polar coordinates, while the bundling requires the Cartesian coordinates.

In the following, it is illustrated how a PMF can be transformed to the FHRR format. To represent the PMF of the attribute in the vector space, a codebook B:={bᵢ}ᵢ₌₁ⁿ is first generated, where bᵢ∈ [symbol] ^{d}. For a discrete attribute, a codebook with n unrelated basis vectors bᵢ is used. For representing the PMF of a continuous attribute, a codebook with basis vectors generated by fractional power encoding is used, where the basis vector corresponding to an attribute value v is defined by exponentiation of a randomly chosen basis vector e using the value as the exponent, i.e., bᵥ=e^{v}. Details on how to create the codebooks for discrete and continuous attributes are provided further below. Each PMF is represented through the normalized weighted superposition with the values in the PMF used as weights and the corresponding codewords as basis vectors:

a^{(i,j)}:=g(p^{(i,j)})=norm(Σₖ₌₁ⁿp^{(i,j)}[k]·bₖ), (1)

where norm(·) normalizes the magnitude of every phasor of a d-dimensional complex-valued vector (see FIG. 3a). Every attribute PMF is transformed separately to its corresponding vectorized representation, e.g., the PMF of the attribute number is transformed to aₙᵤₘ^{(i,j)}:=g(pₙᵤₘ^{(i,j)}).

VSA-based probabilistic abduction and execution is now discussed.

The PMFs are mapped to the FHRR format where the vectorized attributes are represented, and we can use the VSA algebra to implement the functions embedded in the underlying rules. Let us consider the arithmetic plus rule for the number attribute, which is treated as continuous and shown in FIG. 4B. In each row, the number of objects in the third panel is the sum of the number of objects in the first two panels. As this rule is of continuous nature, the PMFs are represented using the fractional power encoding. The vectorized representations of PMFs obtained in equation (1) are bound to compute rᵢ vectors for the first and second row using the first two panels:

rᵢ⁺=a^{(i,1)}⊙a^{(i,2)},i∈{1,2}. (2)

To better understand equation (2), let us assume that the distribution of the PMFs of the context panels is maximally compact, i.e., the values in pₙᵤₘ^{(i,j)} are “1” at the correct number of objects and “0” elsewhere. Then, the bound vector of the first row can be formulated as r₁⁺=e^{v}^{₁}⊙e^{v}^{₂}=e^{v}^{₁}^{+v}^{₂}, where v₁ and v₂ are the number of objects in the first and second panel. If the rule applies, i.e., v₃=v₁+v₂, it is expected for the bound vector r₁⁺ to be identical to the vectorized representation of the last panel in the row a^{(1, 3)}=e^{v}^{₃}=e^{v}^{₁}^{+v}^{₂}, thanks to the properties of fractional power encoding.

For supporting arbitrary PMFs, the rule may be validated using the similarity between the bound vectors. Combining the row-wise similarities with additional constraints yields an estimation of the rule probability:

u[arithmeticplus]=sim(r₁⁺,a^{(1,3)})·sim(r₂⁺,a^{(2,3)})·hₐ(a^{(3,1)},a^{(3,2)}), (3)

where hₐ( [symbol] ) is an additional rule-dependent constraint. When the rule probability for the arithmetic plus is the highest among all possible rules, the vectorized representation of the number attribute for the missing panel is estimated by

â^{(3,3)}=a^{(3,1)}⊙a^{(3,2)}. (4)

This bound vector represents the estimation of the PMF. If the PMFs in the last row are maximally compact, the bound vector corresponds to the correct number of objects of the missing panel. Otherwise, the bound vector represents a superposition of the correct number vector and additional terms which can be considered as noise terms, stemming from the smaller non-zero contributions in the PMF.

To compute the PMF of the missing panel attribute, an associative memory search may be performed between the bound vector and all atomic vectors in the codebook B, followed by a softmax computation:

\hat{p}ₙᵤₘ^{(3,3)}=softmax(sᵣ·[sim(â^{(3,3)},b₁),sim(â^{(3,3)},b₂), . . . ,sim(â^{(3,3)},bₙ)]), (5)

where sᵣ=40 is an inverse softmax temperature.

Next, it is discussed how the NVSA backend supports the rules with the discrete treatment of the attributes such as the distribute three rule. Without loss of generality, the method for the position attribute in the panel constellation is described with a 3×3 grid (see FIG. 4C). The position is described with a 9-bit code where a “1” indicates that the position is occupied inside the 3×3 grid. This 9-bit position index p takes values from 1 to n=511, considering the constraint of having at least one object per panel. A different value of the position attribute (from 1 to n) appears in each of the three panels of a row. The distribute three requires that the same values appear in each row with a distinct permutation. The same holds with respect to the columns.

The position PMF of every panel is transformed using equation (1) in combination with a discrete codebook B. These vectorized representations are used to compute the product vectors for the first and second rows and columns of the context matrix:

rᵢ=a^{(i,1)}⊙a^{(i,2)}⊙a^{(i,3)}, (6)

cⱼ=a^{(1,j)}⊙a^{(2,j)}⊙a^{(3,j)},i,j∈{1,2}. (7)

Equations (6) and (7) describe a VSA-based conjunctive formula grounded over the row and column being considered, respectively. For example, given a set of arbitrary PMFs in a row, the resulting product vector (r₁ or r₂) is unique. However, for any order of PMFs in the row, the computed product vectors are the same due to the commutative property of the binding operation. This property is exploited to detect whether the distribute three rule applies by simply checking if the product vectors are similar among rows and columns, i.e., sim(r₁, r₂)>>0 and sim(c₁, c₂)>>0, and combining them together to estimate the rule probability

u[distribute three]=sim(r₁,r₂)·sim(c₁,c₂)·h_{d}(a^{(1,1)},a^{(2,1)})·h_{d}a^{(1,3)},a^{(2,3)}, (8)

where h_{d}( [symbol] ) is an additional constraint (described in detail further below). To execute the rule, two vectors (a^{(3,1)} and a^{(3,2)}) are first unbound from one of the row product vectors (r₁ or r₂), which results in an unbound vector â^{(3,3)}. The PMF \hat{p}ₚₒₛ^{(3,3)} of the missing panel is estimated by the associate memory in equation (5) which searches on the values of the position attribute.

The associative memory search is only limited to the n atomic vectors in the codebook B; hence, the NVSA backend requires [symbol] (n) in time and space. This is a significant reduction compared to other approaches which search through all possible rule implementations, demanding up to [symbol] (n³) in time and space. For example, the previously described distribute three rule on the attribute position would have

$$( \begin{matrix}n = 511 \\ 3\end{matrix} ) \cdot 12 \geq 26 \cdot {10}^{7}$$

different rule implementations in the 3×3 grid constellation which is prohibitive to compute. This exhaustive rule search forces the neuro-symbolic logical approaches to limit the search space at the cost of lower accuracy. The approach taken with NVSA efficiently covers the entire search space by simple binding and unbinding operations on the vectorized representations followed by a linear associative memory search whose time and space complexity is set as the cube root of the exhaustive search space. Details on the implementation of the artihmetic minus, the progression, and the constant rule are provided further below.

### Training of the NVSA Frontend: Further Details

A universal NVSA frontend may be mutually trained on all training constellations by enumerating all possible positions and merging the identical positions across constellations. For an image panel X, containing k objects, with k target indices Y:={yᵢ}ᵢ₌₁^{k}, the trainable parameters θ of ResNet-18 are optimized to maximize the similarity between its output query q=f_{θ}(X) and the bundled vector w_{y}_{₁}⊕ . . . ⊕w_{y}_{ₖ}. Due to the similarity preserving property of the bundling operation, maximizing the similarity between the query vector and the bundled vector is equivalent to maximizing the similarity between the query vector and each object vector:

θ*=argmax_{θ}sim(f_{θ}(X),w_{y}_{₁}⊕ . . . ⊕w_{y}_{ₖ}) (9)

≈argmax_{θ}sim(f_{θ}(X),w_{y}_{₁})+ . . . +sim(f_{θ}(X),w_{y}_{ₖ}). (10)

Equation (9) may be optimized by means of an advantageous additive cross-entropy loss, defined as

$$ℒ ( X , Y , θ ) := \qquad ( 11 )$$

$$- log \frac{{e}^{{s}_{l} \cdot ( sim ( {f}_{θ} ( X ) , {w}_{{y}_{1}} ) + … + sim ( {f}_{θ} ( X ) , {w}_{{y}_{k}} ) ) )}}{{e}^{{s}_{l} \cdot ( sim ( {f}_{θ} ( X ) , {w}_{{y}_{1}} ) + … + sim ( {f}_{θ} ( X ) , {w}_{{y}_{k}} ) ) )} + {\sum }_{i = 1}^{m} {e}^{{s}_{l} \cdot ( sim ( {f}_{θ} ( X ) , {w}_{{y}_{i}} ) )}} ,$$

where sₗ is an inverse softmax temperature. The loss is optimized using the batched stochastic gradient descent by exclusively updating the parameters θ while freezing W. As the cosine similarity is bound between −1 and +1 and the softmax function embedded in the cross-entropy loss is scale sensitive, the logit vector is scaled with a scalar sₗ, serving as an inverse softmax temperature for improved training.

### PMF Computation: Further Details

Every panel is represented with the attribute PMFs describing the distribution of the attribute values inside the panel. First, the object PMFs are determined by one-hot encoding the attribute values of the detected objects. To guarantee numerical stability in the NVSA, the one-hot distribution may be smoothened by convolving it with a Laplace distribution with diversity b=0.05. This yields the object PMFs vₑₓᵢₛₜ^{(k)}, v_{type}^{(k)}, v_{size}^{(k)}, and v_{color}^{(k)} for every object inside a panel, indexed by its position k inside the panel. vₑₓᵢₛₜ^{(k)} is a 2-dimensional vector containing the probability of object presence at position k.

Finally, the PMFs of the different objects are combined to five PMFs representing the attributes of the panel. The constellation is known to the reasoning backend; hence, the dimensions of the PMFs that depend on the constellations (i.e., position, number) are known, too. The position PMF represents the probability of object occupancy inside a panel. An occupancy p is described with the set Iₚ containing the occupied positions, e.g., I₁={1} represents the case where only the first object is occupied, and I₅₁₁={1, 2, 3, . . . , 9} the case where all objects are occupied in a 3×3 grid. The position PMF is derived by

pₚₒₛ[j]=Π_{k∈I}_{ⱼ}vₑₓᵢₛₜ^{(k)}[0]. (12)

For the attribute number, the PMF is derived from the position PMF with

$${p}_{n u m} [ j ] = {\sum }_{k = 1}^{{n}_{p o s}} {p}_{pos} [ k ] , \qquad ( 13 )$$

$$s . t .$$

$$j = \vert {I}_{k} \vert$$

where |Iₖ| represents the number of occupied positions in the set Iₖ. For the attributes type, size, and color, the PMFs are determined by combining the position PMF with the corresponding attribute PMFs. For example, the PMF for the attribute type is determined by

p_{type}[j]=Σᵢ₌₁ⁿ^{ₚₒₛ}pₚₒₛ[i]Π_{k∈I}_{ᵢ}v_{type}^{(k)}[j] (14)

In some RPM tests, the values of some attributes inside a panel can be different, e.g., the types are different. We represent this case with an inconsistency state for the attributes type, size, and color, by extending the PMF with an additional probability, e.g., for the attribute type

p_{type}[n_{type}+1]=1−Σⱼ₌₁ⁿ^{_{type}}p_{type}[j]. (15)

PMF Transformation of Discrete and Continuous Attributes: Further Details

The PMF of a discrete attribute is represented with a vector space which is spanned with unrelated basis vectors B:={bᵢ}ᵢ₌₁ⁿ. Each basis vector bᵢ∈ [symbol] ^{d} is a d-dimensional, complex-valued, unitary vector, where the angle of each vector element is drawn from a uniform distribution U(−π, π). For representing the PMF of a continuous attribute, we use a vector space which is spanned with a basis taken from fractional power encoding. Building the basis of the fractional power encoding begins with randomly initializing one single unitary basis vector e∈ [symbol] ^{d}. The basis vector corresponding to any arbitrary attribute value v is defined by exponentiation of the basis vector e using the value as the exponent. The exponentiation can be efficiently computed using the angular representation of the basis vector and supports continuous exponents (i.e., values). For example, the basis vector corresponding to the value “5.3” is e^{5.3}. In RPMs, however, we exclusively encounter attributes with integer values, e.g., the size attribute of an object is enumerated from 1 to n=6. Thus, the underlying codebook is of finite size and is defined as B:={eⁱ}ᵢ₌₁ⁿ. Using this codebook, a PMF of a given continuous attribute is then transformed using the weighed superposition defined in equation (1).

### End-to-End Training of the Frontend and Backend Combined

If desired, end-to-end training of the entire NVSA, namely—of the backend and frontend combined—may be performed. Such end-to-end training does not require any ground-truth object attributes.

To perform the end-to-end training, the combined backend and frontend may be made differentiable. Specifically, the neuro-vector perception frontend may be made differentiable by replacing the final one-hot PMF computation (discussed above) with a marginalization block that includes a summation block and a normalization block. The summation block computes the sum of all attribute combinations for each attribute value. For example, for computing the value 0 of the color attribute, the sum is computed over all attribute combinations that contain the color value 0. The normalization block may be softmax activation with a learnable temperature, s. The term “block,” as used in this paragraph, refers to module of software code that performs the described actions.

### Experimental Results

NVSA was evaluated on the RAVEN dataset as well as the I-RAVEN dataset. For learning the parameters of our neuro-vector perception, the 16 panels (eight context panels and eight answer panels) were extracted, and ground-truth attribute values provided by the dataset were used as meta-labels. The neuro-vector perception was exclusively trained on the training data from RAVEN while being tested on RAVEN and I-RAVEN (I-RAVEN provides different answer panels, while the constellations and the context matrices stay the same as in RAVEN). Moreover, the perception part was also trained on a partial training set containing only 6000 training samples (instead of full 42,000 samples) by taking training samples from the individual constellations based on a share that corresponds to their number of possible locations, e.g., 3×3 grid provides 9× more training samples than the center.

The neuro-vector perception (i.e., ResNet-18) was trained using batched stochastic gradient descent (SGD) with a weight decay of le-4 and a momentum of 0.9. All the training hyperparameters were determined based on the panel accuracy on the validation set of RAVEN. A search through possible batch sizes {64, 128, 256, 512} and scaling factors sₗ∈{1, 3, 5, 10, 15, 20} was conducted. For the training on the full training set, the hyperparameter search yielded an optimal batchsize of 256, a scaling factor sₗ=1, and 100 training epochs. Similarly, a batchsize of 256, a scaling factor sₗ=5, and 300 training epochs yielded optimal training outcome on the partial training set. Moreover, an exponentially decaying learning rate is used, initially set to 0.1 and decreased by 10× at a decay rate of 30 and 90 in full and partial training, respectively.

All experiments were repeated five times with a different random seed. The average results are presented below, to account for training variability.

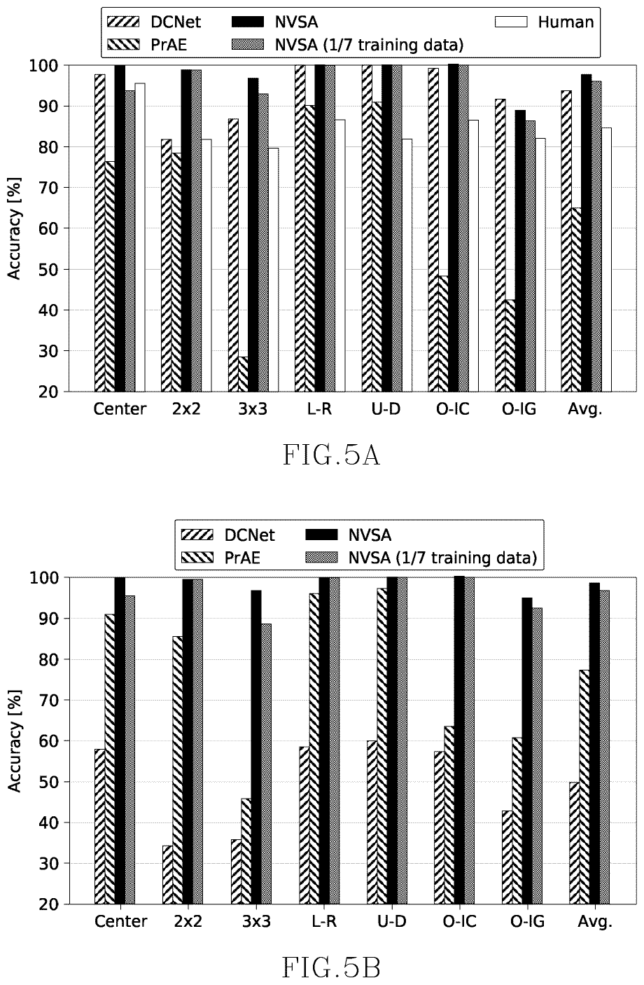

FIGS. 5A and 5B compare the classification accuracy on the RAVEN and I-RAVEN datasets, respectively, with the state-of-the-art models in pure deep neural networks, DCNet.

On the RAVEN dataset, NVSA with the full training samples achieves an accuracy of 97.7%, outperforming DCNet by 4.1% and PrAE by 32.7%. Specifically, NVSA retains high accuracy (≥96.5%) in the 2×2 grid and 3×3 grid.

NVSA achieves the highest accuracy on the I-RAVEN dataset too (98.8%), while the end-to-end deep learning approaches (DCNet and PrAE) show a large drop in accuracy. NVSA also significantly outperforms, by over 20%, the neuro-symbolic PrAE approach that shows 65.0% on RAVEN, and 77.0% on I-RAVEN, on average. Training NVSA on the partial training set, i.e., using 1/7 samples of the full training set, yields only a marginal loss on RAVEN (96.0% vs. 97.7%) and I-RAVEN (96.6% vs. 98.8%).

Tables 1 and 2 show a comparison of the accuracy and computation time, respectively, of the NVSA backend with the PrAE reasoning backend by providing the ground-truth attribute values. The PrAE reasoning backend reaches over 99% for four constellations, while it shows lower accuracies (94.21%-95.68%) for the 2×2 grid, the 3×3 grid, and the out-in grid. The root cause of the low accuracy in these three constellations appears to be the approximations made in the search by applying restrictions to get faster execution. In the experiments, therefore, search restrictions were removed from PrAE to create an unrestricted PrAE. This increases the accuracy of those three constellations to 97.5%-99.22%, and improves the average accuracy to 99.35%.

While the compute time of the unrestricted PrAE remains similar for most configurations, it increases rapidly for the 3×3 grid, requiring 15,408 minutes (10.7 days) instead of the previous 648 minutes (10.8 hours) in the PrAE with restricted search. The unrestricted PrAE also required a large amount of memory, 53 GB. In contrast, NVSA reduces the compute time on the 3×3 grid to 55.5 minutes, which is 277× faster than the unrestricted PrAE, and the memory demand to less than 10 GB, while maintaining the high accuracy (97.40% vs. 97.50%). The average accuracy of the NVSA reasoning backend is also on par with the unrestricted PrAE (99.36% vs. 99.35%).

TABLE 1
Reasoning accuracy (%) when solving 2000 examples
on the RAVEN test sets using the ground-truth panel attributes.
Avg denotes the average accuracy over all test constellations

| | Accuracy (%) | | | | | | | |
|---|---|---|---|---|---|---|---|---|
| Method | Avg | Center | 2 × 2 | 3 × 3 | L-R | U-D | O-IC | O-IG |
| PrAE | 97.79 | 99.99 | 94.67 | 94.21 | 99.98 | 99.95 | 99.99 | 95.68 |
| Unrestricted | 99.35 | 100 | 98.82 | 97.50 | 99.99 | 99.94 | 99.99 | 99.22 |
| PrAE | | | | | | | | |
| NVSA backend | 99.36 | 100 | 99.04 | 97.34 | 99.94 | 99.98 | 100 | 99.25 |

TABLE 2
CPU compute time (minutes) when solving 2000 examples on
the RAVEN test sets using the ground-truth panel attributes.
Avg denotes the average accuracy over all test constellations

| | CPU compute time (minutes) | | | | | | |
|---|---|---|---|---|---|---|---|
| Method | Center | 2 × 2 | 3 × 3 | L-R | U-D | O-IC | O-IG |
| PrAE | 0.4 | 1.0 | 648.1 | 0.8 | 0.8 | 0.7 | 1.4 |
| Unrestricted | 0.6 | 1.1 | 15,408.5 | 1.0 | 1.1 | 0.9 | 2.2 |
| PrAE | | | | | | | |
| NVSA backend | 1.0 | 2.0 | 55.5 | 1.6 | 1.6 | 1.5 | 2.5 |

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description and claims, the term “training” (and its grammatical inflections) refers to training of a machine learning algorithm (such as, but not limited to, an artificial neural network).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
one or more computer processors;
one or more computer readable storage media; and
program instructions stored on at least one of the one or more computer readable storage media for execution by at least one of the one or more computer processors, the stored program instructions comprising instructions to:
receive image data associated with an artificial intelligence (AI) task;
automatically process the image data using a frontend that comprises an artificial neural network (ANN) and a vector-symbolic architecture (VSA); and
automatically process an output of the frontend using a backend that comprises a symbolic logical reasoning engine, to solve the AI task.

2. The system of claim 1, wherein the processing of the image data using the frontend comprises:
using the VSA to define possible nested compositional structures that may be depicted in the image data; and
using the ANN to transform the image data to a hierarchy of objects depicted in the image data, according to the possible nested compositional structures defined by the VSA.

3. The system of claim 2, wherein:
each of the objects is represented by performing a binding operation between attributes of the respective object; and
a scene comprising the objects is represented by performing a bundling operation between the object representations of the objects comprised in the scene.

4. The system of claim 3, wherein:
a query vector of the ANN resembles a bundling of vectorized object representations from a dictionary of the possible nested compositional structures; and
the processing of the image data by the frontend further comprises:
decomposing the query vector into its constituent vectorized object representations;
inferring the attributes of the objects based on the decomposed query vector; and
producing probability mass functions (PMFs) based on the inferred attributes of the objects.

5. The system of claim 4, wherein the processing of the output of the frontend using the backend comprises:
transforming the PMFs into Fourier holographic reduced representations (FHRRs); computing, based on the FHRRs, a rule probability of each possible rule of the AI task; and
selecting the rule with the highest probability as a solution to the AI task.

6. The system of claim 5, wherein the computation of the rule probability comprises:
performing binding and unbinding operations on the FHRRs.

7. The system of claim 2, wherein the program code is further executable to automatically learn weights of the ANN using an additive cross-entropy loss that is optimized by updating trainable parameters of the ANN while a dictionary of the possible nested compositional structures frozen is maintained frozen.

8. The system of claim 1, wherein the AI task is an abstract visual reasoning task.

9. The system of claim 1, wherein:
a combination of the frontend and the backend is differentiable; and
the program code is further executable to automatically perform end-to-end training of the combination of the frontend and the backend.

10. A method comprising:
receiving, by one or more processors, image data associated with an artificial intelligence (AI) task;
automatically processing, by one or more processors, the image data using a frontend that comprises an artificial neural network (ANN) and a vector-symbolic architecture (VSA); and
automatically processing, by one or more processors, an output of the frontend using a backend that comprises a symbolic logical reasoning engine, to solve the AI task.

11. The method of claim 10, wherein the processing of the image data using the frontend comprises:
using, by one or more processors, the VSA to define possible nested compositional structures that may be depicted in the image data; and
using, by one or more processors, the ANN to transform the image data to a hierarchy of objects depicted in the image data, according to the possible nested compositional structures defined by the VSA.

12. The method of claim 11, wherein:
each of the objects is represented by performing a binding operation between attributes of the respective object; and
a scene comprising the objects is represented by performing a bundling operation between the object representations of the objects comprised in the scene.

13. The method of claim 12, wherein:
a query vector of the ANN resembles a bundling of vectorized object representations from a dictionary of the possible nested compositional structures; and
the processing of the image data by the frontend further comprises:
decomposing, by one or more processors, the query vector into its constituent vectorized object representations;
inferring, by one or more processors, the attributes of the objects based on the decomposed query vector; and
producing, by one or more processors, probability mass functions (PMFs) based on the inferred attributes of the objects.

14. The method of claim 13, wherein the processing of the output of the frontend using the backend comprises:
transforming, by one or more processors, the PMFs into Fourier holographic reduced representations (FHRRs);
based on the FHRRs, computing, by one or more processors, a rule probability of each possible rule of the AI task; and
selecting, by one or more processors, the rule with the highest probability as a solution to the AI task.

15. The method of claim 14, wherein the computation of the rule probability comprises: performing, by one or more processors, binding and unbinding operations on the FHRRs.

16. The method of claim 11, further comprising:
automatically learning, by one or more processors, weights of the ANN using an additive cross-entropy loss that is optimized by updating trainable parameters of the ANN while a dictionary of the possible nested compositional structures frozen is maintained frozen.

17. The method of claim 10, wherein the AI task is an abstract visual reasoning task.

18. The method of claim 10, wherein:
a combination of the frontend and the backend is differentiable; and
the method further comprises automatically performing, by one or more processors, end-to-end training of the combination of the frontend and the backend.

19. A computer program product comprising:
one or more computer readable storage media and program instructions stored on the one or more computer readable storage media, the stored program instructions comprising instructions to:
receive image data associated with an artificial intelligence (AI) task;
automatically process the image data using a frontend that comprises an artificial neural network (ANN) and a vector-symbolic architecture (VSA); and
automatically process an output of the frontend using a backend that comprises a symbolic logical reasoning engine, to solve the AI task.

20. The computer program product of claim 19, wherein:
the processing of the image data using the frontend comprises:
using the VSA to define possible nested compositional structures that may be depicted in the image data; and
using the ANN to transform the image data to a hierarchy of objects depicted in the image data, according to the possible nested compositional structures defined by the VSA.
